(19) United States
(12) Patent Application Publication
(10) Pub. No.: US 2026/0350554 A1
(43) Pub. Date: Nov. 5, 2026

(54) INFORMATION PROCESSING TERMINAL, STORAGE MEDIUM, AND INFORMATION PROCESSING SYSTEM

(71) Applicant: Konica Minolta, Inc., Tokyo (JP)

(72) Inventor: Tsumoru Matsuura, Toyohashi-shi (JP)

(73) Assignee: Konica Minolta, Inc., Tokyo (JP)

(21) Appl. No.: 19/662,511

(22) Filed: Apr. 29, 2026

(30) Foreign Application Priority Data
Apr. 30, 2025 (JP) 2025-075468

(51) Int. Cl. G06Q 10/30; G03G 15/00; G03G 15/22; G06K 7/14; H04N 1/00

(52) U.S. Cl. CPC G06Q 10/30; G03G 15/228; G03G 15/5016; G03G 15/5079; G03G 15/55; G06K 7/1417; H04N 1/00037; H04N 1/00079; H04N 1/00244; H04N 2201/0094

(57) ABSTRACT

An information processing terminal includes a hardware processor. The hardware processor acquires, from a plurality of apparatuses, state information regarding states of apparatus main bodies of the apparatuses and a plurality of units attached to the apparatus main body. The hardware processor determines, for each unit, the state of the unit based on the state information. Based on a determination result, the hardware processor extracts, for each unit type, the apparatus to which the unit having a same or a similar state is attached. The hardware processor controls a display to display an extraction result.

### CROSS-REFERENCE TO RELATED APPLICATION

The entire disclosure of Japanese Patent Application No. 2025-075468, filed on April 30, 2025, including description, claims, drawings and abstract is incorporated herein by reference.

### BACKGROUND OF THE INVENTION

### Technical Field

The present disclosure relates to an information processing terminal, a storage medium, and an information processing system.

### Description of Related Art

In recent years, it is desired to eliminate unnecessary disposal in order to realize a recycling-oriented society. Accordingly, manufacturers determine, from among main sections or components of multifunction peripherals (MFPs) collected from users, which of those are usable, and reuse those determined to be reusable. Such work for reuse is referred to as refurbishment work.

In this regard, Japanese Unexamined Patent Application Publication No. 2021-135440 discloses an image forming apparatus that controls a message regarding work of replacing a waste toner box, the operation being performed concurrently with urging replacement of the toner cartridge when a remaining amount of toner in a toner cartridge of a multifunction peripheral (MFP) becomes low. Japanese Unexamined Patent Application Publication No. 2015-203716 discloses an image forming apparatus that performs, at one time, adjustment of various parameters at the time of factory shipment of the multifunction peripheral (MFP).

However, the improvement in work efficiency achieved by the image forming apparatuses described in Japanese Unexamined Patent Application Publication No. 2021-135440 and Japanese Unexamined Patent Application Publication No. 2015-203716 relates to work performed for each MFP on an individual basis, and does not improve work efficiency for a plurality of MFPs. Therefore, there is a problem in that it is not possible to grasp an overall status of the MFP subject to refurbishment work and to plan and execute work procedures and work guidelines. As used herein, the work procedures and work guidelines mean, for example, selecting a plurality of multifunction peripherals (MFPs) that require the same type of work and collectively performing the work on the selected multifunction peripherals (MFPs). Further, this also applies to selecting a plurality of MFPs that require work requiring experience and skills, allocating the plurality of MFPs to persons having the required experience and skills, and collectively performing the work on the plurality of MFPs.

### SUMMARY OF THE INVENTION

The present disclosure has been made in view of the above-described problem, and an object of the present disclosure is to improve work efficiency when refurbishment work is performed on two or more apparatuses.

According to one aspect of the present disclosure, an information processing terminal reflecting one aspect of the present disclosure includes,
a hardware processor,
wherein,
the hardware processor acquires, from a plurality of apparatuses, state information regarding states of apparatus main bodies of the apparatuses and a plurality of units attached to the apparatus main body,
the hardware processor determines, for each unit, the state of the unit based on the state information,
based on a determination result, the hardware processor extracts, for each unit type, the apparatus to which the unit having a same or a similar state is attached, and
the hardware processor controls a display to display an extraction result.

According to another aspect of the present disclosure, the storage medium reflecting one aspect of the present disclosure is a non-transitory computer-readable storage medium storing a program that causes a computer of an information processing terminal to perform,
acquiring, from a plurality of apparatuses, state information regarding states of apparatus main bodies of the apparatuses and a plurality of units attached to the apparatus main bodies,
determining, for each unit, a state of the unit based on the state information,
based on a determination result, extracting, for each unit type, the apparatus to which the unit having a same or a similar state is attached, and
controlling a display to display an extraction result.

According to another aspect of the present disclosure, the information processing system reflecting one aspect of the present disclosure includes:
a server apparatus including a database that stores state information regarding states of apparatus main bodies of a plurality of apparatuses and a plurality of units attached to the apparatus main bodies; and
an information processing terminal including a hardware processor,
wherein,
the hardware processor acquires the state information from the server apparatus,
the hardware processor determines, for each unit, a state of the unit based on the state information,
based on a determination result, the hardware processor extracts, for each unit type, the apparatus to which the unit having a same or a similar state is attached, and
the hardware processor controls a display to display an extraction result.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a block diagram illustrating a functional configuration of an information processing system 100;

FIG. 2 is a schematic configuration diagram illustrating an image forming apparatus 1;

FIG. 3 is a flowchart illustrating a first acquisition determination process;

FIG. 4 is a diagram illustrating a determination result obtained by the first acquisition determination process;

FIG. 5 is a flowchart illustrating a first extraction process;

FIG. 6 is a diagram illustrating an extraction result obtained by the first extraction process;

FIG. 7 is a flowchart illustrating a second acquisition determination process;

FIG. 8 is a diagram illustrating a determination result of the second acquisition determination process;

FIG. 9 is a flowchart illustrating a second extraction process;

FIG. 10 is a diagram illustrating an extraction result obtained by the second extraction process;

FIG. 11 is a flowchart illustrating a first display control process;

FIG. 12 is a diagram illustrating a positional relationship between a holder of an information processing terminal 2 and four image forming apparatuses 1;

FIG. 13 is a diagram illustrating an example of a result obtained by performing the first display control process based on the positional relationship shown in FIG. 12;

FIG. 14 is a flowchart illustrating a pairing control process;

FIG. 15 is a diagram illustrating an example of a notification provided via a screen display;

FIG. 16 is a diagram illustrating an example of the notification provided by a screen display;

FIG. 17 is a flowchart illustrating an imaging/reading process; and

FIG. 18 is a block diagram illustrating a functional configuration of the information processing system 200 according to a modification example.

### DETAILED DESCRIPTION

Hereinafter, one or more embodiments of the present disclosure will be described with reference to the drawings. However, the scope of the invention is not limited to the disclosed embodiments.

Hereinafter, one or more embodiments of the present disclosure will be described with reference to the drawings. However, the scope of the present disclosure is not limited to the embodiments described below or the accompanying drawings.

### 1. Configuration of the Information Processing System

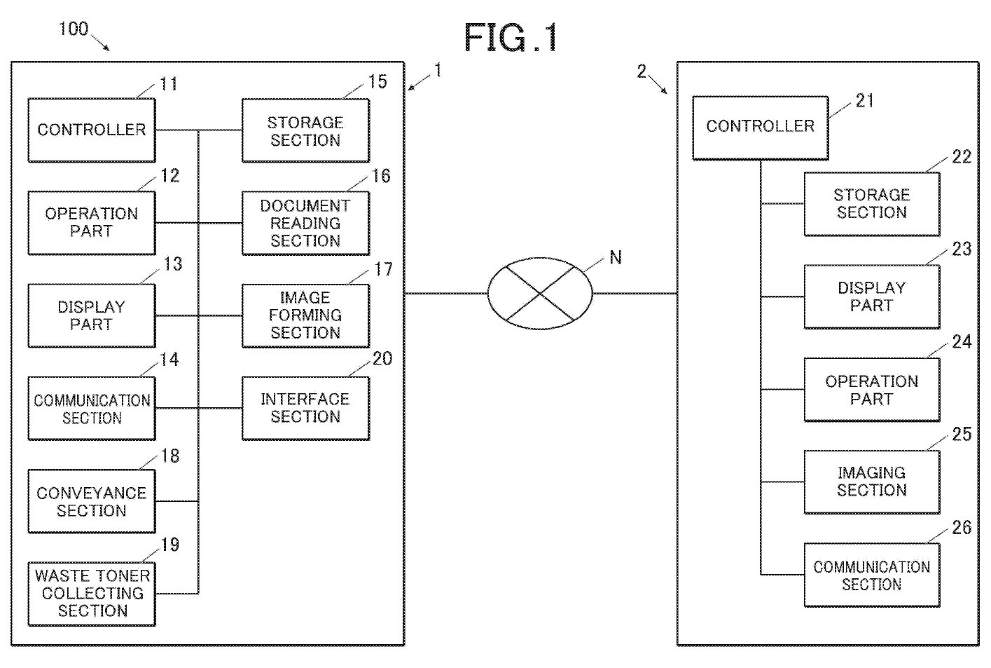

FIG. 1 is a block diagram illustrating a functional configuration of an information processing system 100 according to the present embodiment.

The information processing system 100 includes a plurality of image forming apparatuses 1 and an information processing terminal 2. The plurality of image forming apparatuses 1 and the information processing terminal 2 transmit and receive information via a communication network N.

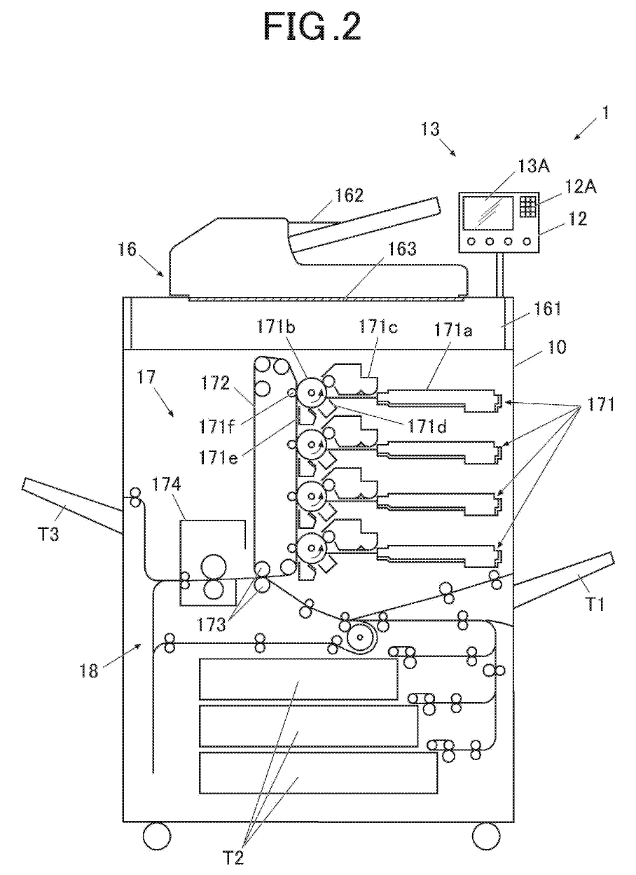

FIG. 2 is a schematic configuration diagram illustrating the image forming apparatus 1.

The image forming apparatus 1 is a multifunction peripheral (MFP) having, in addition to an image forming function, a copy function, a scan function, a facsimile function, and the like.

The image forming apparatus 1 includes a plurality of units and an apparatus main body 10 to which the plurality of units are attached. Examples of the unit include a writing unit 171, a fixing unit 174, and a waste toner conveying unit, as will be described below.

In recycling work for the image forming apparatus 1, a worker of a manufacturer removes reusable units from the apparatus main body 10 of the image forming apparatus 1 whose apparatus main body 10 is not reusable. Next, the worker attaches the unit removed from the image forming apparatus to be discarded to the apparatus main body 10 of another reusable image forming apparatus 1. The manufacturer sells or rents the other image forming apparatus 1 to which the unit is attached as a refurbished image forming apparatus.

The information processing terminal 2 is a terminal, such as a smartphone or a tablet, that acquires state information regarding the image forming apparatus 1 from the plurality of image forming apparatuses 1 and performs processing for improving efficiency of refurbishment work. The state information includes unit state information and main-body state information, which will be described later. For example, the information processing terminal 2 determines, for a plurality of image forming apparatuses 1, whether a unit needs replacement, whether the unit is reusable, and the like, based on state information regarding the image forming apparatus 1, and displays a determination result, thereby providing information necessary for a worker to efficiently proceed with the work.

The communication network N includes a local area network (LAN), a wide area network (WAN), the Internet, or the like. The communication network N also includes short-range wireless communication schemes classified as a wireless personal area network (WPAN) and a wireless local area network (WLAN), such as Bluetooth (registered trademark) and Wi-Fi (registered trademark).

### Image Forming Apparatus

The image forming apparatus 1 includes a controller 11 (hardware processor), an operation part 12, a display part 13 (display), a communication section 14, a storage section 15, a document reading section 16, an image forming section 17, a conveyance section 18, a waste toner collecting section 19, and an interface (I/F) section 20.

The controller 11 includes a central processing unit (CPU), a random access memory (RAM), a read-only memory (ROM), and the like.

The CPU of the controller 11 reads a program stored in the ROM or the storage section 15, loads the program into the RAM, and controls each section of the image forming apparatus 1 in accordance with the loaded program. For example, the controller 11 performs image processing on image data of a job based on job settings input from outside via the communication section 14. Next, the controller 11 causes the conveyance section 18 to feed a sheet and causes the image forming section 17 to form an image on the sheet and fix the image on the sheet.

The operation part 12 includes an operation key 12A, a touch screen integrally formed with the display part 13, and the like, and outputs, to the controller 11, an operation signal corresponding to an operation performed on the operation key 12A or the touch screen.

The display part 13 includes a liquid crystal display (LCD) panel 13A and the like, and displays display information, such as an operation screen, in accordance with instructions from the controller 11. When the image forming apparatus 1 is in a refurbish mode, the worker can cause the display part 13 to display state information regarding the image forming apparatus 1. The state information is, for example, unit state information or main-body state information, which will be described later, or a two-dimensional code, such as a QR code (registered trademark), representing such information.

The communication section 14 includes a network card or the like, is connected to a communication network N, and transmits and receives information to and from an external device on the communication network N.

The storage section 15 includes a storage device such as a non-volatile semiconductor memory or a hard disk.

The storage section 15 stores programs, files, and the like readable by the controller 11.

The storage section 15 stores, for each removable unit included in the image forming apparatus 1, unit state information indicating a state of the unit. The unit state information is, for example, counter information regarding the unit. For example, when the unit is replaced with a new unit, the counter information of the unit is initialized and thus becomes "0" again. The unit state information may be, for example, a value obtained by a sensor that detects deterioration of a main portion of the unit.

The storage section 15 stores main-body state information indicating a state of a housing serving as the apparatus main body 10 of the image forming apparatus 1. The main-body state information is information indicating an amount of use of the apparatus main body 10 of the image forming apparatus 1. The main-body state information includes a cumulative number of printed sheets, an elapsed use time, and the like from a start of use of the apparatus main body 10 of the image forming apparatus 1.

The document reading section 16 includes an automatic document feeder, a scanner section 161, a placement tray 162 on which a document sheet is placed, a platen glass 163, and the like.

The automatic document feeder includes a mechanism for conveying a document sheet, document conveyance rollers, and the like, and conveys the document sheet along a predetermined conveyance route under the control of the controller 11.

The scanner section 161 includes a light source, an optical system including a reflecting mirror and the like, and an imaging element, and reads the image of the document sheet conveyed along the predetermined conveyance route or the document sheet placed on the platen glass 163.

The image forming section 17 forms and fixes the image of four colors on the sheet in accordance with pixel values of the four colors, C, M, Y, and K, for each pixel of the image data subjected to image processing.

As shown in FIG. 2, the image forming section 17 includes four writing units 171, an intermediate transfer belt 172, a secondary transfer roller 173, and a fixing unit 174.

The four writing units 171 are arranged in series (tandem) along a belt surface of the intermediate transfer belt 172 for the four colors C, M, Y, and K, and form images of the respective colors C, M, Y, and K on the sheet.

The writing unit 171 includes an exposure section 171a, a photosensitive drum unit 171b, a developing section 171c, a charging section 171d, a cleaning section 171e, a primary transfer roller 171f, and the like.

The photosensitive drum unit 171b includes a rotating conductive cylindrical member (photoreceptor). The charging section 171d charges the photoreceptor. The exposure section 171a includes a semiconductor laser light source and, under control of the controller 11, drives the semiconductor laser light source and the like based on the image data to scan and irradiate the photoreceptor charged by the charging section 171d with laser light, thereby exposing the photoreceptor. Under control of the controller 11, the developing section 171c supplies toner to the photoreceptor using a charged developing roller, and develops an electrostatic latent image formed on the photoreceptor by exposure. The images respectively formed on the photoreceptors of the four writing units 171 are sequentially transferred (primary transfer) onto the intermediate transfer belt 172 in a superimposed manner by the respective primary transfer rollers 171f. A color toner image including the respective colors is formed on the intermediate transfer belt 172. After the primary transfer, the cleaning section 171e removes the toner remaining on the photoreceptor.

The intermediate transfer belt 172 is an endless belt stretched around a plurality of rollers and, under control of the controller 11, rotates in accordance with rotation of each roller.

Under the control of the controller 11, the secondary transfer roller 173 transfers (secondary transfer) the toner image formed on the intermediate transfer belt 172 onto the sheet conveyed from the manual sheet feed tray T1 or the sheet feed tray T2.

The fixing unit 174 includes a heating roller and a pressure roller.

Under control of the controller 11, the fixing unit 174 fixes the image to the sheet by heating and pressing the sheet on which the image has been formed.

The conveyance section 18 includes a sheet feed roller and the like, and, in accordance with an instruction from the controller 11, conveys, by the sheet feed roller, a sheet from the manual sheet feed tray T1 or the sheet feed tray T2 to the image forming section 17. The conveyance section 18 discharges, to the sheet ejection tray T3, the sheet after being fixed by the fixing unit 174. The conveyance section 18 includes a reversing section serving as a sheet reversing path, and, when double-sided printing is performed, reverses the sheet having the image fixed on a front surface thereof and conveys the sheet to the image forming section 17 again.

The waste toner collecting section 19 includes a waste toner conveying unit, a waste toner collection container, and the like.

The waste toner collecting section 19 conveys, by the waste toner conveying unit, waste toner removed in the image forming section 17, and accumulates the waste toner in the waste toner collection container.

The interface (I/F) section 20 is an interface for connection with an external device (e.g., a Universal Serial Bus (USB) interface).

### Information Processing Terminal

The information processing terminal 2 includes a controller 21 (a hardware processor), a storage section 22, a display part 23 (display), an operation part 24, an imaging section 25, and a communication section 26.

The controller 21 includes a central processing unit (CPU), a random access memory (RAM), a read-only memory (ROM), and the like.

The central processing unit (CPU) of the controller 21 reads a program stored in the read-only memory (ROM) or the storage section 22, loads the program into the random access memory (RAM), and controls each section of the image forming apparatus 1 in accordance with the loaded program.

The storage section 22 includes a storage device such as a nonvolatile semiconductor memory or a hard disk.

The storage section 22 stores programs, files, and the like readable by the controller 21.

The storage section 22 stores list information of image forming apparatuses 1 that are targets of refurbishment work performed by the worker.

The storage section 22 stores inventory information on replacement units for the respective units of the image forming apparatus 1.

The display part 23 includes, for example, a liquid crystal display (LCD) panel, and displays display information such as an operation screen in accordance with instructions from the controller 21.

The operation part 24 includes operation keys and the touch screen integrated with the display part 23, and outputs, to the controller 21, the operation signal corresponding to operations thereon.

The imaging section 25 is a functional section that captures the image of the subject to generate the image data, and includes an imaging apparatus such as an optical camera that includes a CCD sensor, a CMOS sensor, or the like. In accordance with instructions from the controller 21, the imaging section 25 captures the image and generates the image data by performing A/D conversion on the electrical signal obtained through photoelectric conversion by the CCD sensor or the like. The controller 21 acquires state information regarding the image forming apparatus 1 based on the image data generated by the imaging section 25. The image data is, for example, the two-dimensional code such as the QR code (registered trademark), or the image data obtained by capturing the image of the unit state information or the main-body state information displayed on the display part 13. When the image data is obtained by capturing the image of the unit state information or the main-body state information as text, the controller 21 performs image analysis using OCR or the like and acquires the unit state information or the main-body state information.

The communication section 26 is a communication module or communication interface for communicating with the image forming apparatus 1 via a network N in a wired or wireless manner. For example, the communication module is a short-range wireless communication module such as Wi-Fi (registered trademark) or Bluetooth (registered trademark), or a wide-area wireless communication module such as 5G, 4G, or LTE. The image forming apparatus 1 and the information processing terminal 2 are connected via a wired or wireless LAN or the Internet, and are capable of transmitting and receiving the information.

The controller 21 can acquire, via the communication section 26, the information regarding a distance between the information processing terminal 2 and the image forming apparatus 1. The means for acquiring the information are, for example, an RTT (Round-Trip Time) method in which the time taken for the signal to travel back and forth between Bluetooth devices is measured and the distance is calculated from the time.

### 2. Operation of the Information Processing System

The operation of the information processing system 100 will be described. The information processing system 100 performs a first acquisition determination process, a first extraction process, a second acquisition determination process, a second extraction process, a first display control process, and a second display control process. In addition, the information processing system 100 performs the pairing control process, the imaging/reading process, and the like.

Each process will be described below.

### First Acquisition Determination Process

The acquisition determination process is a process in which the information processing terminal 2 acquires, via the communication section 26, the state information regarding the image forming apparatus 1 from the plurality of image forming apparatuses 1, determines whether the unit needs to be replaced or is reusable, and displays the determination result on the display part 23.

In the acquisition determination process, the image forming apparatus 1 is in the refurbish mode, and the information processing terminal 2 is in a state in which the information processing terminal 2 is capable of acquiring, via the communication section 26, the state information regarding the image forming apparatus 1 from the plurality of image forming apparatuses 1.

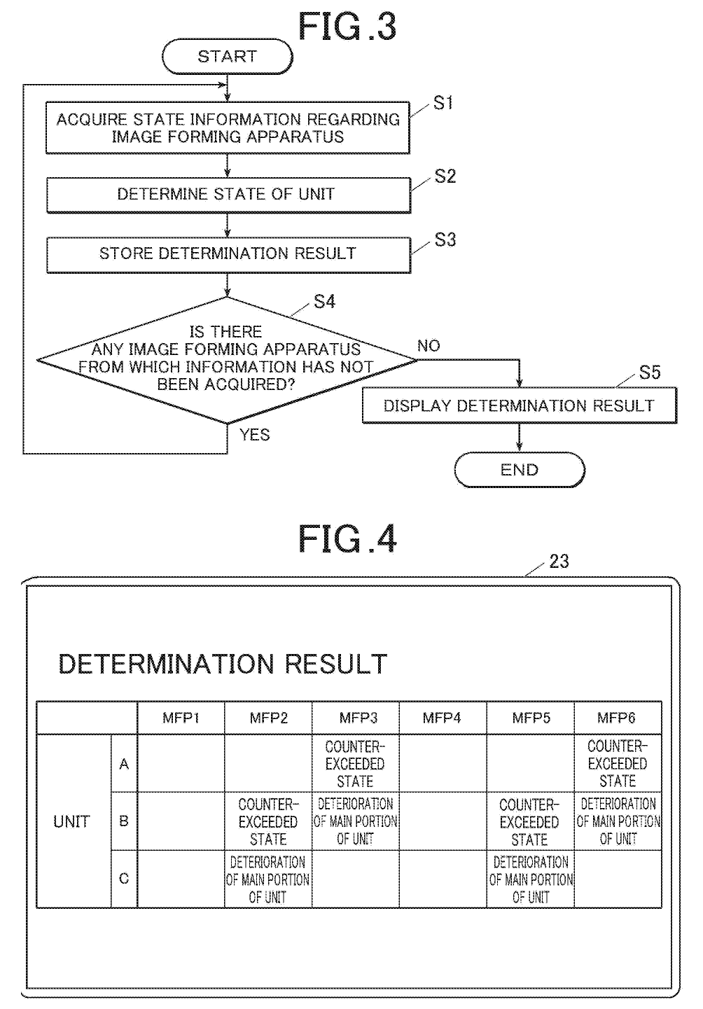

FIG. 3 is a flowchart illustrating the first acquisition determination process.

The controller 21 acquires, via the communication section 26, the state information regarding the image forming apparatus 1 from the plurality of image forming apparatuses 1 capable of communication (step S1). The state information regarding the image forming apparatus 1 includes the unit state information and the main-body state information. At this time, the controller 21 functions as an acquisition section that acquires, from the plurality of image forming apparatuses 1, the state information regarding the states of the plurality of units and the apparatus main body 10.

Based on the unit state information included in the obtained state information, the controller 21 determines, for each unit of the image forming apparatus 1, the state related to work for reuse of the image forming apparatus 1 (step S2). The controller 21 functions as a first determination section that determines, for each unit, the state related to work for reuse of the image forming apparatus 1 based on the unit state information. The state is, for example, a counter-exceeded state, deterioration of the main portion of the unit, or the like. The counter-exceeded state is determined when a counter value included in the counter information exceeds a predetermined value. Deterioration of the main portion of the unit is determined when the value obtained by the sensor detecting the deterioration of the main portion satisfies a predetermined criterion. In addition, if there is no state to be particularly described, a corresponding field is left blank.

The controller 21 stores, in the storage section 22, the determination result obtained in step S2 (step S3).

The controller 21 compares the state information acquired in step S1 with list information, stored in the storage section 22, of the image forming apparatuses 1 that are targets of refurbishment work by the worker, and determines whether there is any image forming apparatus for which the state information has not been acquired.

If there is the image forming apparatus for which the state information has not been acquired (step S4; YES), the controller 21 executes the operation of step S1 again.

If there is no image forming apparatus for which the state information has not been acquired (step S4; NO), the controller 21 displays the determination result on the display part 23 (step S5). With this display, the user can ascertain, for the unit installed in each apparatus, the counter-exceeded state, the deterioration of the main portion of the unit, and the like, and can perform the work such as removing the unit or can plan such work.

FIG. 4 illustrates an example of displaying a determination result. MFP 1 to MFP 6 are examples of the plurality of image forming apparatuses 1, each of which is a multifunction peripheral (MFP). Units A to C are examples of the units of the image forming apparatus 1. The units A to C include, for example, the writing unit 171, the fixing unit 174, and the waste toner conveying unit.

### First Extraction Process

The first extraction process is a process of extracting, for each unit type, the image forming apparatus 1 having installed thereon the unit in the same or similar state, from the determination result obtained in the first acquisition determination process.

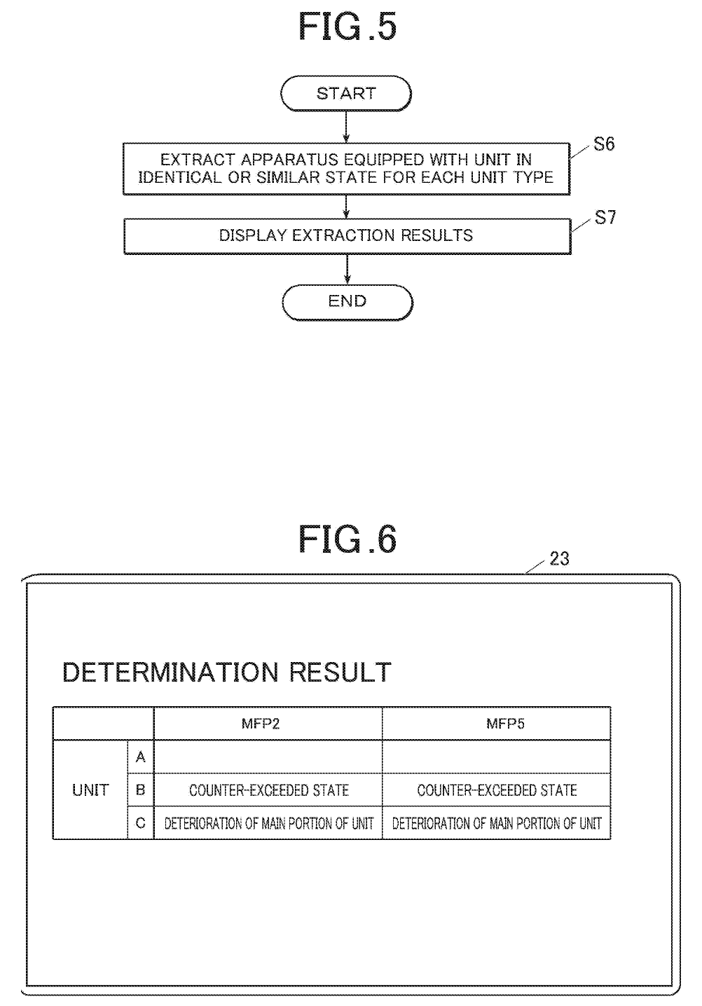

FIG. 5 is a flowchart illustrating a first extraction process.

The controller 21 extracts, for each unit type, the state information on the image forming apparatus 1 in which the unit in the same state or the similar state is installed, based on the determination result obtained in the acquisition determination process (step S6). The controller 21 displays, as a display controller, the extraction result on the display part 23 (step S7). With this display, the user can collectively determine what work to perform on the plurality of image forming apparatuses 1 each having installed thereon the unit in the same or a similar state, and can proceed with the work based on the determination.

In the first extraction process, the controller 21 functions as a first extraction section that extracts, for each unit type, the apparatus in which the unit in the same state or the similar state are installed, based on the determination result obtained by the first determination section.

FIG. 6 is an example of a screen displayed on the display part 23 as a result of the first extraction process. FIG. 6 shows a result of extracting the unit B that is in the counter-exceeded state. In this case, the user can collectively determine to perform the work corresponding to the counter-exceeded state on the unit B of each of two image forming apparatuses MFP 2 and MFP 5, and can perform the work based on the determination. The work corresponding to the counter-exceeded state includes, for example, the replacement of the unit.

### Second Acquisition Determination Process

The second acquisition determination process includes acquiring, by the information processing terminal 2 via the communication section 26, the state information regarding the image forming apparatus 1 from the plurality of image forming apparatuses 1, determining whether unit replacement is necessary or whether the unit is reusable, and displaying the determination result on the display part 23.

In the acquisition determination process, the image forming apparatus 1 is in the refurbish mode, and the information processing terminal 2 is in the state in which the information processing terminal 2 is capable of acquiring, via the communication section 26, the state information regarding the image forming apparatus 1 from the plurality of image forming apparatuses 1.

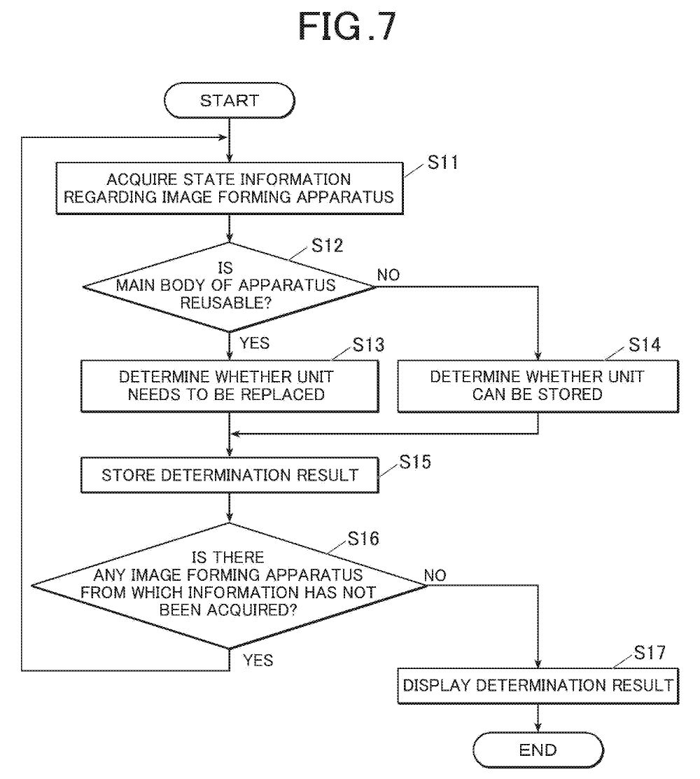

FIG. 7 is a flowchart illustrating the second acquisition determination process.

The controller 21 acquires, via the communication section 26, the state information regarding the image forming apparatus 1 from the plurality of image forming apparatuses 1 capable of communication (step S11). The state information regarding the image forming apparatus 1 includes the unit state information and the main-body state information.

The controller 21 determines, based on the main-body state information among the acquired state information, whether the apparatus main body 10 of each image forming apparatus 1 is reusable. For example, when the cumulative number of printed sheets included in the main-body state information exceeds a predetermined value, the controller 21 determines that the apparatus main body 10 is not reusable. At this time, the controller 21 functions as a second determination section configured to determine whether the apparatus main body 10 is reusable. When the apparatus main body 10 of the image forming apparatus 1 is reusable (step S12; YES), the controller 21 determines, based on the unit state information among the acquired state information, whether each unit of the image forming apparatus 1 needs to be replaced (step S13). For example, when the value obtained by the sensor detecting the deterioration of the main portion of the unit included in the unit state information satisfies a predetermined condition, the controller 21 determines that the replacement of the unit is required. When the apparatus main body 10 of the image forming apparatus 1 is not reusable (step S12; NO), the controller 21 determines, based on the unit state information from among the acquired state information, whether each unit of the image forming apparatus 1 is storable (step S14). For example, when the value obtained by the sensor detecting the deterioration of the main portion of the unit included in the unit state information satisfies the predetermined condition, the controller 21 determines that the unit cannot be stored. In steps S13 and S14, the controller 21 functions as the first determination section configured to determine, for the unit, whether the replacement is required or whether the unit is reusable.

The controller 21 stores, in the storage section 22, the determination result obtained in step S13 or step S14 (step S15), and proceeds to step S16.

The controller 21 compares the state information acquired in step S11 with list information, stored in the storage section 22, of the image forming apparatuses 1 that are targets of the refurbishment work by the worker, and determines whether there is any image forming apparatus for which the state information has not been acquired. If there is the image forming apparatus from which the state information has not been acquired (step S16; YES), the controller 21 proceeds to step S11 again.

If there is no image forming apparatus for which the state information has not been acquired (step S16; NO), the controller 21 displays the determination result on the display part 23 (step S17). With this display, the user can understand or determine what work is required for which unit of which apparatus. For example, with respect to a unit determined to require replacement, the user can understand that replacement of the unit is necessary. In addition, with respect to the unit determined not to require replacement, the user can determine whether the work is unnecessary or, for example, cleaning is required. In addition, with respect to the unit determined to be storable, the user can understand that the unit needs to be removed and stored in a predetermined place. In addition, for the unit determined to be non-storable, the user can understand that the unit needs to be removed and discarded.

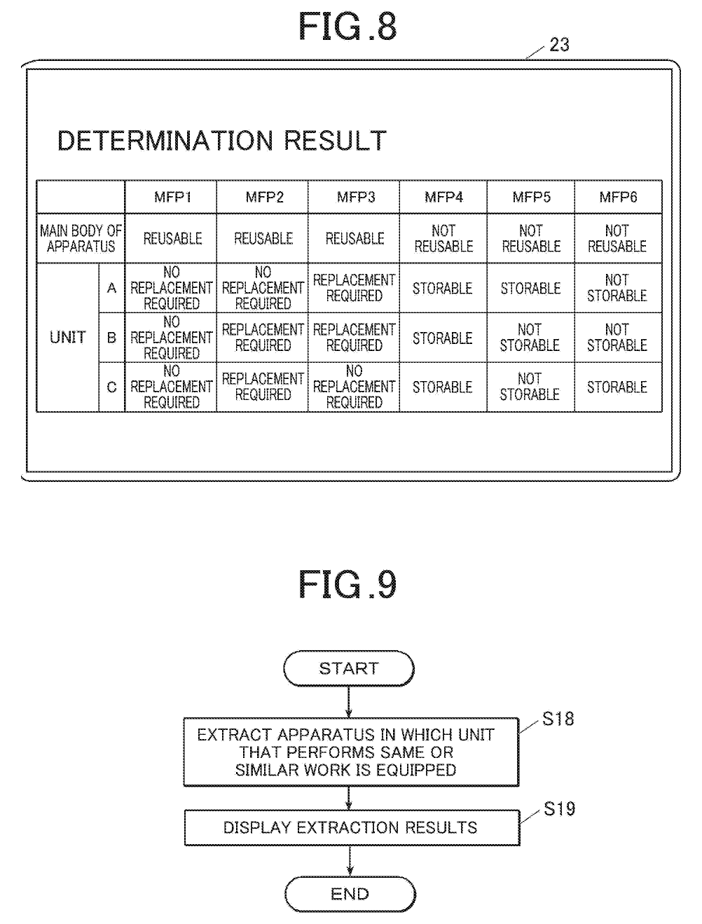

FIG. 8 illustrates an example display of the determination result.

The controller 21 functions as a third determination section configured to determine whether the unit is reusable when the second determination section determines that the apparatus main body 10 is not reusable, and to determine whether the replacement of the unit is required when the second determination section determines that the apparatus main body 10 is reusable.

### Second Extraction Process

The second extraction process is the process of extracting, based on the determination result of the third determination section, the apparatus on which the unit involving the same or the similar work is mounted.

FIG. 9 is a flowchart illustrating a second extraction process.

Based on the determination result of the third determination section, the controller 21 extracts, in the work for reuse of the image forming apparatus 1, the apparatus equipped with the unit that involves the same or the similar work (step S18). The controller 21 displays the extraction result on the display part 23 (step S19). With this display, the user can collectively perform the work on the plurality of image forming apparatuses 1 equipped with the unit that involves the same or the similar work.

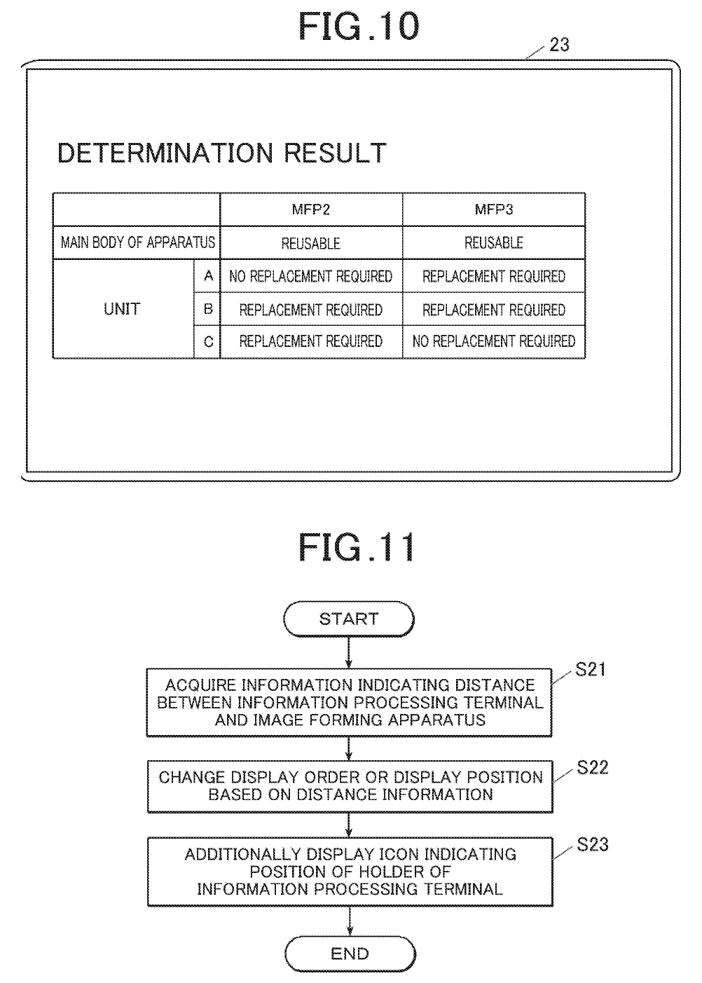

FIG. 10 illustrates an example of a screen displayed on the display part 23 as a result of performing the second extraction process. FIG. 10 shows the results of extracting apparatuses in which the unit B requires replacement. In this case, the user can collectively perform the replacement work of the unit B for the MFP 2 and the MFP 3.

In the second extraction process, the controller 21 functions as a second extraction section configured to extract, from the extraction result of the first extraction section, the apparatus equipped with the unit that involves the same or the similar work in the work for the purpose of reusing the apparatus.

### First Display Control Process

The first display control process is a process in which, for display on the display part 23, a display order or a display position is changed based on the information on the distance between the information processing terminal 2 and the image forming apparatus 1, and an icon indicating a position of a holder of the information processing terminal 2 is additionally displayed.

FIG. 11 is a flowchart illustrating the first display control process.

The controller 21 acquires the information on the distance between the information processing terminal 2 and the image forming apparatus 1 via the communication section 26 (step S21). The controller 21 changes the display order or the display position for display on the display part 23 based on the acquired distance information (step S22). The controller 21 further displays the icon indicating the position of the holder of the information processing terminal 2 (step S23).

In the first display control process, the controller 21 functions as a display controller that, for display on the display part 23, changes the display order or the display position based on the distance information between the information processing terminal 2 and the image forming apparatus 1 and additionally displays an icon indicating a position of a terminal holder.

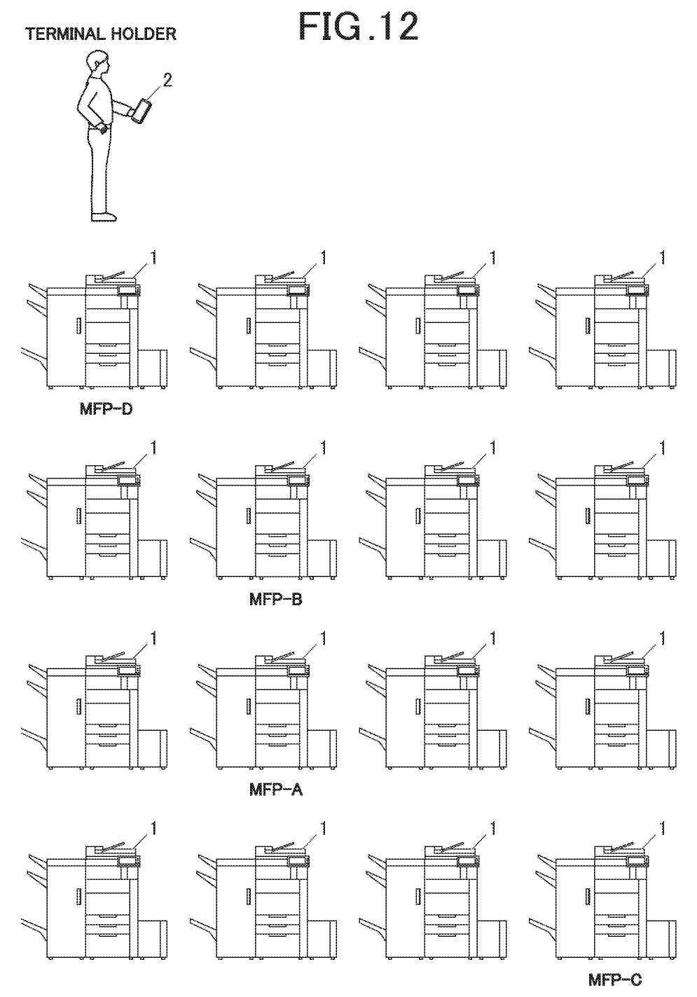

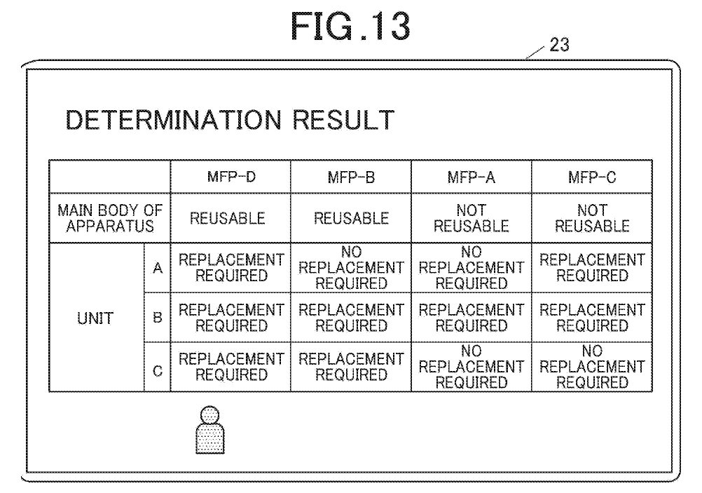

FIG. 12 is a diagram illustrating a positional relationship between the holder of the information processing terminal 2 and sixteen image forming apparatuses 1. MFP-A, MFP-B, MFP-C, and MFP-D are examples of the image forming apparatuses 1 (multifunction peripherals (MFPs)) extracted by the second extraction section. The extraction condition here is that the image forming apparatus in which the unit B is determined to require replacement is extracted. FIG. 13 is a diagram illustrating an example of a result obtained by performing the first display control process based on the positional relationship shown in FIG. 12. In FIG. 13, with respect to four image forming apparatuses MFP-A to MFP-D, a change is made such that the information of the apparatus is displayed from the left in order of the distance between the terminal and the apparatus starting with a close distance, and the icon indicating the position of the terminal holder is additionally displayed below the information of the apparatus having the closest distance. Accordingly, the terminal holder can perform the work, among the apparatuses to be worked on, in order starting from the apparatus closest to the terminal holder.

### Second Display Control Process

The second display control process is a process of changing the display order or the display position of items displayed on the display part 23 based on stock information of a replacement unit stored in the storage section 22.

The controller 21 changes the display order or the display position based on the stock information regarding the replacement unit.

In the second display control process, the controller 21 functions as a display controller that changes the display order or the display position for display on the display part based on the stock information of the replacement unit.

### Pairing Control Process

The pairing control process is a process in which, when the image forming apparatus 1 enters a specific mode, the image forming apparatus 1 automatically performs pairing between the information processing terminal and the image forming apparatus 1, automatically acquires the state information, and, when the image forming apparatus 1 exits the specific mode, automatically cancels the pairing between the information processing terminal and the image forming apparatus 1.

Hereinafter, a case in which the specific mode is the refurbish mode will be described.

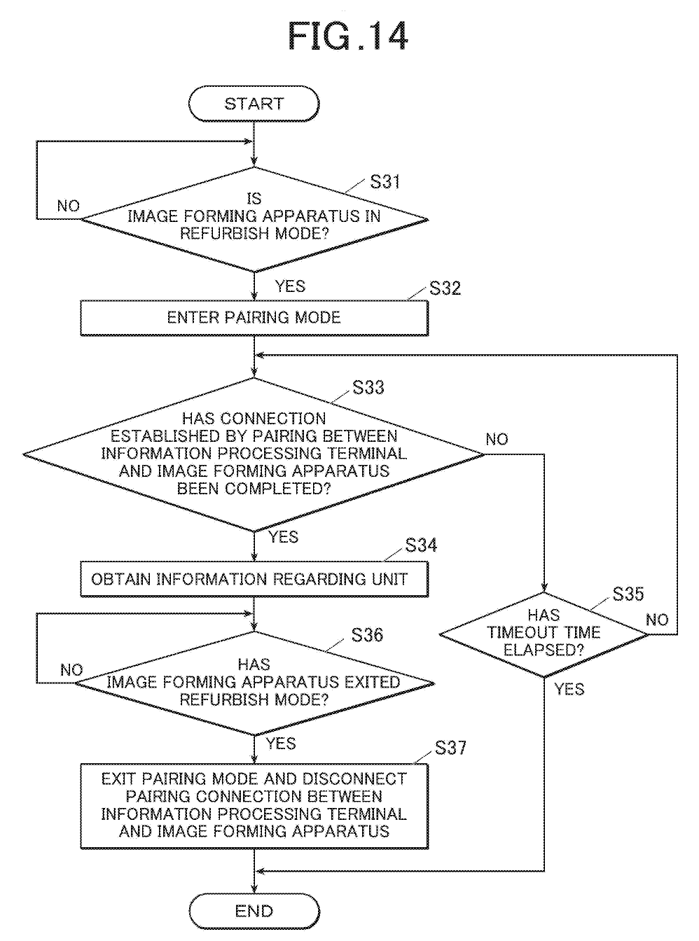

FIG. 14 is a flowchart illustrating a pairing control process.

The controller 21 determines, via the communication section 26, whether the image forming apparatus 1 is in the refurbish mode. When the image forming apparatus 1 is in the refurbish mode (step S31; YES), the controller 21 enters a pairing mode for performing pairing between the information processing terminal 2 and the image forming apparatus 1 (step S32).

When a pairing connection between the information processing terminal 2 and the image forming apparatus 1 is completed (step S33; YES), the controller 21 acquires the state information regarding the unit attached to the apparatus main body 10 of the apparatus subjected to pairing (step S34).

When the pairing connection between the information processing terminal 2 and the image forming apparatus 1 is not completed (step S33; NO), the controller 21 determines whether time from a start of the connection to a current time point exceeds a predetermined timeout time. If the timeout time has elapsed (step S35; YES), the controller 21 terminates an automatic connection process. If the timeout time has not elapsed (step S35; NO), the controller 21 returns to step S33.

The controller 21 determines, via the communication section 26, whether the image forming apparatus 1 has exited the refurbish mode and has entered a normal mode. When the image forming apparatus 1 has exited the refurbish mode and has entered the normal mode (step S36; YES), the controller 21 operates as follows. The controller 21 exits the pairing mode for pairing between the information processing terminal 2 and the image forming apparatus 1, and releases the connection established by pairing (step S37).

The controller 21 functions as follows in the pairing control process. The controller 21 functions as a first connection controller that automatically performs the pairing between the information processing terminal 2 and the image forming apparatus 1 when the image forming apparatus 1 enters the specific mode. When the pairing between the information processing terminal 2 and the image forming apparatus 1 is completed, the controller 21 functions as a first acquisition controller that automatically acquires, from the image forming apparatus 1, the state information regarding the unit mounted on the apparatus main body 10 of the image forming apparatus 1. The controller 21 functions as a second connection controller that automatically releases pairing between the information processing terminal and the image forming apparatus 1 when the image forming apparatus 1 exits the specific mode.

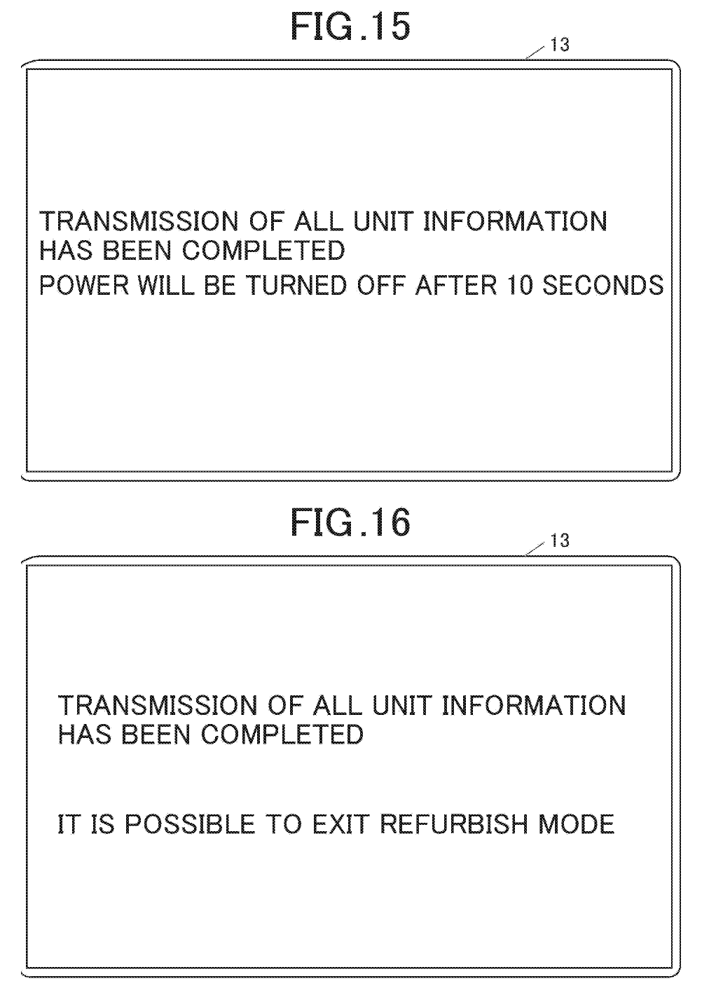

After step S34, the controller 21 may turn off power to the image forming apparatus 1 via the communication section 26. At this time, a notification may be provided on the display part 13 by a screen display as shown in FIG. 15. Further, after step S34, the controller 21 may, via the communication section 26, cause the display part 13 to display the screen as shown in FIG. 16 to notify the user that exiting the refurbish mode is permitted. At this time, when the controller 21 acquires the state information regarding the unit mounted on the apparatus main body 10 of the image forming apparatus 1 for pairing, the controller 21 functions as a notification section that notifies that the image forming apparatus 1 may be powered off or may exit the specific mode. This can prevent the user from forgetting to power off the apparatus or to exit the specific mode.

In addition, such notification may be omitted, and the image forming apparatus 1 may be powered off or caused to exit the specific mode via the communication section 26. In this case, when the controller 21 acquires the state information regarding the unit mounted on the apparatus main body 10 of the apparatus that is the target of pairing, the controller 21 functions as an operation controller that automatically powers off the apparatus or causes the apparatus to exit the specific mode. Thus, the user can be spared the trouble of powering off the image forming apparatus 1 or performing the operation to cause the image forming apparatus 1 to exit the specific mode.

The method for the information processing terminal 2 to acquire the state information from the image forming apparatus 1 is not limited to the above-described acquisition using the network or the like. In this method, the image displayed on the display part 13 of the image forming apparatus 1 may be captured by the imaging section 25 of the information processing terminal 2, and the captured image data may be analyzed.

The method by which the information processing terminal 2 acquires the state information from the image forming apparatus 1 may allow selection between acquisition via the communication network and acquisition by capturing the image data displayed on the display part 13 of the image forming apparatus 1. In this case, the controller 21 functions as a selection section that selects, as a method of acquiring the state information, either acquisition via the communication network or acquisition by capturing the image data.

The method by which the information processing terminal 2 acquires the state information from the image forming apparatus 1 may be automatically determined, based on a model state of the image forming apparatus 1, to be either acquisition via the communication network or acquisition by capturing the image data displayed on the display part 13 of the image forming apparatus 1. The model state is, for example, information indicating whether a network connection is present. For example, for a model that is not connected to the network, the controller 21 determines to acquire the information by capturing the image data. In this case, the controller 21 functions as a determination section that determines, based on the model information of the apparatus, whether the state information is to be acquired via the communication network or by capturing the image data.

Hereinafter, as a method for the information processing terminal 2 to acquire the state information from the image forming apparatus 1, the operation will be described in which the information processing terminal 2 captures, with the imaging section 25 of the information processing terminal 2, the image displayed on the display part 13 of the image forming apparatus 1 and analyzes the captured image data.

The captured image data includes the two-dimensional code such as the QR code, and video information.

### Imaging/Reading Process

The imaging/reading processing is a process in which, when the image forming apparatus 1 enters the specific mode, the state information regarding the image forming apparatus 1 is displayed on the display part 13, the displayed state information is captured, and, after completion of the capturing, the state information is read based on the captured image, thereby acquiring the state information.

Hereinafter, a case in which the specific mode is the refurbish mode will be described.

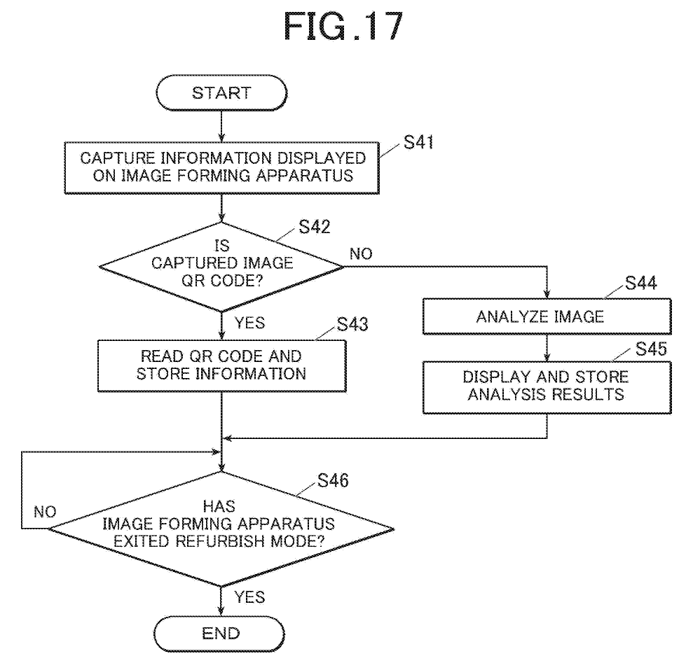

FIG. 17 is a flowchart illustrating an imaging/reading process.

In an initial state of the imaging/reading processing, the image forming apparatus 1 is in the refurbish mode, and the image indicating the state information regarding the image forming apparatus 1 is displayed on the display part 13. The controller 21 receives user operation and captures, using the imaging section, the image displayed on the display part 13 (step S41).

If the captured image is the QR code (step S42; YES), the controller 21 reads the QR code and stores the read information in the storage section 22 (step S43).

If the captured image is not the QR code (step S42; NO), the controller 21 analyzes the image (step S44). The analysis method is, for example, OCR (optical character recognition/reader). The controller 21 displays the analysis result on the display part 13 and stores the analysis result that has been displayed in the storage section 22 (step S45).

The controller 21 determines, via the communication section 26, whether the image forming apparatus 1 has exited the refurbish mode and has entered the normal mode. If the image forming apparatus 1 has exited the refurbish mode (step S46; YES), the process ends.

### 3. Modification Example

Although the present embodiment has been described above, the specific configuration is not limited to the present embodiment described above and may be modified without departing from the scope of the invention. Modification examples of the present embodiment will be described below. In the modification examples, components having configurations similar to those in the above embodiment are denoted by the same reference numerals, and descriptions thereof are omitted.

A modification example will be described in which a server apparatus 3 is added in addition to the information processing terminal 2 of the present embodiment and, in the modification example, the server apparatus 3 stores the state information regarding the image forming apparatus 1 that has been acquired and/or stored by the storage section 22.

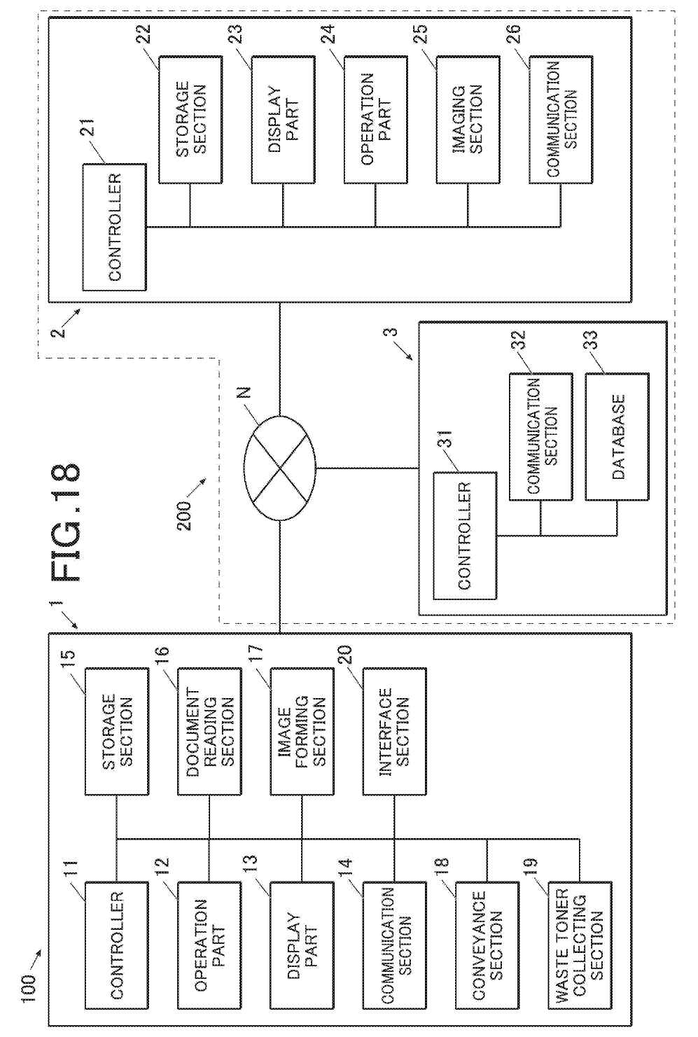

FIG. 18 is a block diagram illustrating a functional configuration of an information processing system 200 according to the present modification example.

The information processing system 200 includes an information processing terminal 2 and a server apparatus 3. The information processing terminal 2 and the server apparatus 3 transmit and receive information via the communication network N.

The server apparatus 3 includes a controller 31, a communication section 32, a database 33, and the like.

The controller 31 includes a CPU, a ROM, a RAM, and the like.

The CPU of the controller 31 reads a program stored in the ROM, loads the program into the RAM, and controls various operations of the server apparatus 3 in accordance with the program loaded into the RAM.

The communication section 32 includes a network card or the like.

The communication section 32 enables transmission and reception of data between the server apparatus 3 and the information processing terminal 2.

The database 33 includes a storage device such as a nonvolatile semiconductor memory or a hard disk.

The database 33 stores the state information regarding a plurality of image forming apparatuses 1 that are targets for restoration work, and serves as an image forming apparatus management database.

In a first acquisition determination process, in step S1, the controller 21 acquires, via the communication section 26, the state information regarding the image forming apparatus 1 stored in the database 33. Steps S2 to S5 are the same as those in the present embodiment. In other words, the worker using the information processing terminal 2 can immediately acquire the necessary state information by communicating only with the server apparatus 3, without communicating with the plurality of image forming apparatuses.

### 4. Effects

As described above, the information processing terminal 2 according to the present embodiment includes the acquisition section (controller 21) configured to acquire, from the plurality of image forming apparatuses 1, the state information regarding the state of the apparatus main body 10 of each image forming apparatus 1 and the plurality of units attached to the apparatus main body 10.

The information processing terminal 2 includes the first determination section (controller 21) configured to determine, for each unit, the state of the unit based on the unit state information.

The information processing terminal 2 includes the first extraction section (controller 21) configured to extract, for each unit type, one or more apparatuses in which the unit having the identical or similar state is installed, based on the determination result of the first determination section.

The information processing terminal 2 includes a display controller (controller 21) configured to display the extraction result obtained by the first extraction section on the display part 23.

Accordingly, it is possible to grasp the overall state of the multifunction peripherals (MFPs) that are the target of the refurbishment work, and to devise and execute work procedures and work guidelines. This can improve the work efficiency when performing the refurbishment work on two or more apparatuses.

The information processing terminal 2 includes the second determination section (controller 21) configured to determine whether the reuse is possible based on the main-body state information.

The information processing terminal 2 includes the third determination section (controller 21) configured to determine whether the unit mounted on the apparatus main body 10 is storable when the second determination section determines that the apparatus main body 10 is not reusable, and to determine whether the unit needs to be replaced when the second determination section determines that the apparatus main body 10 is reusable.

The information processing terminal 2 includes the second extraction section (controller 21) configured to extract, based on the determination result of the third determination section (controller 21), the apparatus on which the unit involving the same or similar work is mounted.

The display controller (controller 21) of the information processing terminal 2 displays, on the display part 23, the extraction result obtained by the second extraction section. With this display, the user can collectively perform the work on the plurality of image forming apparatuses 1 each having the unit involving the same or similar work mounted thereon, thereby improving the work efficiency when performing the refurbishment work on two or more apparatuses.

The display controller (controller 21) of the information processing terminal 2 changes the display order or the display position based on the information indicating the distance between the information processing terminal 2 and the image forming apparatus 1, and additionally displays the icon indicating the position of the holder of the terminal. Accordingly, among the apparatuses that are the target of the work, the user can perform the work in order starting with the apparatus closest to the user, thereby improving the work efficiency when performing the refurbishment work on two or more apparatuses.

The acquisition section of the information processing terminal 2 acquires the state information via the communication network N.

The communication network N is Bluetooth.

When the image forming apparatus 1 enters the specific mode, the acquisition section (controller 21) of the information processing terminal 2 automatically performs pairing between the information processing terminal 2 and the image forming apparatus 1, and, upon completion of the pairing, acquires, from the image forming apparatus 1, the state information regarding the states of the apparatus main body 10 and the plurality of units mounted on the apparatus main body 10. Accordingly, pairing and information acquisition can be performed in a single operation, thereby increasing the information acquisition speed and improving work efficiency when refurbishment work is performed on two or more apparatuses.

The information processing terminal 2 includes the notification section configured to notify that, when the state information regarding the unit attached to the apparatus main body 10 of the image forming apparatus 1 that is a pairing target is acquired, the power of the image forming apparatus 1 may be turned off or the image forming apparatus 1 may exit from the specific mode. Accordingly, it is possible to prevent the user from forgetting to turn off the power or exit the specific mode and to prevent the workflow from being hindered, thereby improving the work efficiency when the refurbishment work is performed on two or more apparatuses.

The information processing terminal 2 includes the operation controller configured to automatically turn off the power to the image forming apparatus 1 or cause the image forming apparatus 1 to exit the specific mode when the information processing terminal 2 acquires, from the image forming apparatus 1 that is the pairing target, the state information regarding the unit attached to the apparatus main body 10 of the image forming apparatus 1. Accordingly, this eliminates the need for the user to turn off the power of the image forming apparatus 1 or perform the operation to cause the image forming apparatus 1 to exit the specific mode, thereby improving the work efficiency when the refurbishment work is performed on two or more apparatuses.

The information processing system of the modification example includes, the server apparatus 3 including the database that stores the state information regarding the states of the apparatus main body 10 of each of the plurality of image forming apparatuses 1 and the plurality of units attached to the apparatus main body 10; and the information processing terminal 2 including the acquisition section (controller 21) configured to acquire the state information from the server apparatus 3, the first determination section (controller 21) configured to determine, for each unit, the unit state based on the state information, the first extraction section (controller 21) configured to extract, for each unit type, the apparatus equipped with the unit having the same or similar state from the determination results of the first determination section, and the display controller (controller 21) configured to display the extraction results of the first extraction section on the display part. Accordingly, the worker using the information processing terminal 2 can immediately acquire necessary information by communicating only with the server apparatus 3, without communicating with the plurality of image forming apparatuses 1, thereby improving the work efficiency when performing the refurbishment work on two or more apparatuses.

Although the present disclosure has been described in detail above with reference to the embodiments, the present disclosure is not limited to the embodiments described above, and various modifications may be made without departing from the scope of the present disclosure.

For example, although the above description discloses an example in which a hard disk, a semiconductor nonvolatile memory, or the like is used as a computer-readable medium for a program according to the present disclosure, the present disclosure is not limited to this example. As another computer-readable medium, a portable recording medium such as a CD-ROM may be used.

In addition, the detailed configuration and operation of each apparatus may be modified as appropriate without departing from the scope of the invention.

It should be noted that the term "unit" in the above-described embodiment refers not only to a unit in its ordinary sense, but also to a smaller component constituting the image forming apparatus. However, the component is limited to one capable of recording information equivalent to the unit state information in the above-described embodiment.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An information processing terminal comprising:
a hardware processor,
wherein,
the hardware processor acquires, from a plurality of apparatuses, state information regarding states of apparatus main bodies of the apparatuses and a plurality of units attached to the apparatus main body,
the hardware processor determines, for each unit, the state of the unit based on the state information,
based on a determination result, the hardware processor extracts, for each unit type, the apparatus to which the unit having a same or a similar state is attached, and
the hardware processor controls a display to display an extraction result.

2. The information processing terminal according to claim 1, wherein,
the hardware processor determines, for the apparatus main body, whether the apparatus main body is reusable based on the state information,
the hardware processor determines whether the unit attached to the apparatus main body is storable when the apparatus main body is determined to be not reusable, and determines whether the unit needs to be replaced when the apparatus main body is determined to be reusable,
the hardware processor extracts, based on the determination result, the apparatus to which the unit involving a same or a similar type of work is attached, and
the hardware processor displays the extraction result on the display.

3. The information processing terminal according to claim 2, wherein the hardware processor changes a display order or a display position based on information of a distance between the information processing terminal and the apparatus, and additionally displays an icon indicating a position of a terminal holder.

4. The information processing terminal according to claim 3, wherein the hardware processor changes the display order or the display position based on stock information for a replacement unit.

5. The information processing terminal according to claim 4, wherein the hardware processor acquires the state information via a communication network.

6. The information processing terminal according to claim 5, wherein the communication network is Bluetooth.

7. The information processing terminal according to claim 6, wherein, when the apparatus enters a specific mode, the hardware processor automatically performs pairing between the information processing terminal and the apparatus, and when the pairing is completed, acquires the state information from the apparatus.

8. The information processing terminal according to claim 7, wherein the hardware processor automatically cancels the pairing between the information processing terminal and the apparatus when the apparatus exits the specific mode.

9. The information processing terminal according to claim 8, wherein when the hardware processor acquires the state information regarding the unit attached to the apparatus main body of the apparatus that is a target for pairing, the hardware processor notifies that the apparatus may be turned off or may exit the specific mode.

10. The information processing terminal according to claim 8, wherein when the hardware processor acquires the state information from the apparatus that is a target of pairing, the hardware processor automatically turns off the apparatus or causes the apparatus to exit the specific mode.

11. The information processing terminal according to claim 1, wherein the hardware processor acquires the state information by analyzing image data obtained by capturing an image displayed on the display of the apparatus.

12. The information processing terminal according to claim 11, wherein the captured image data includes a two-dimensional code.

13. The information processing terminal according to claim 12, wherein the captured image data includes video information.

14. The information processing terminal according to claim 1, wherein,
the hardware processor selects, as an acquisition method for the state information, either acquisition via a communication network or acquisition by capturing image data, and
the hardware processor acquires the state information by the selected acquisition method.

15. The information processing terminal according to claim 1, wherein,
based on model information of the apparatus, the hardware processor determines, as an acquisition method of the state information, whether to acquire the state information via a communication network or by capturing image data.
the hardware processor acquires the state information by the determined acquisition method.

16. A non-transitory computer-readable storage medium storing a program that causes a computer of an information processing terminal to perform,
acquiring, from a plurality of apparatuses, state information regarding states of apparatus main bodies of the apparatuses and a plurality of units attached to the apparatus main bodies,
determining, for each unit, a state of the unit based on the state information,
based on a determination result, extracting, for each unit type, the apparatus to which the unit having a same or a similar state is attached, and
controlling a display to display an extraction result.

17. An information processing system comprising:
a server apparatus including a database that stores state information regarding states of apparatus main bodies of a plurality of apparatuses and a plurality of units attached to the apparatus main bodies; and
an information processing terminal including a hardware processor,
wherein,
the hardware processor acquires the state information from the server apparatus,
the hardware processor determines, for each unit, a state of the unit based on the state information,
based on a determination result, the hardware processor extracts, for each unit type, the apparatus to which the unit having a same or a similar state is attached, and
the hardware processor controls a display to display an extraction result.
